(19) United States
(12) Patent Application Publication
(10) Pub. No.: US 2014/0040716 A1
(43) Pub. Date: Feb. 6, 2014

(54) METHOD FOR PERSONALIZING A CALENDAR BY COLLECTING WEB PAGE INFORMATION ACCORDING TO DATA ENTRIES IN THE CALENDAR

(71) Applicant: Fisher Lee, Taipei City (TW)

(72) Inventor: Han-Hong LIN, Fenglin Township (TW)

(73) Assignee: Fisher Lee, Taipei City (TW)

(21) Appl. No.: 13/950,624

(22) Filed: Jul. 25, 2013

(30) Foreign Application Priority Data
Aug. 6, 2012 (TW) 101128211

(51) Int. Cl. G06F 17/22

(52) U.S. Cl. CPC G06F 17/2235
USPC 715/205

(57) ABSTRACT

The present invention is to provide a method for personalizing a calendar by collecting web page information according to data entries in the calendar, which is applicable to a network system including a server and a terminal device connected to the server through the Internet and installed with calendar software. The method is designed that, after a user writes predetermined data entry into a calendar created by the calendar software and shown on the terminal device, the terminal device automatically collects web page information matching with the data entry from the Internet by way of the calendar software and the server. Once the web page information collected is properly sorted, the terminal device imbeds the web page information into the calendar or adds the web page information to the calendar as a plugin, thereby creating a personalized calendar which enables the user to obtain the desired information conveniently and rapidly.

### FIELD OF THE INVENTION

The present invention relates to a personalized calendar, more particularly to a method for personalizing a calendar by collecting web page information according to data entries inputted by a user through a terminal device, so as to enable the terminal device to automatically collect web page information matching with the data entry from the Internet by way of a calendar software installed therein and a server connected therewith through the Internet. Once the web page information collected is properly sorted, the terminal device imbeds the web page information into the calendar or adds the web page information to the calendar as a plugin, thereby creating the personalized calendar which enables the user to obtain the desired information conveniently and rapidly.

### BACKGROUND OF THE INVENTION

With the rapid development of network technology and the advancement of microelectronic technology, terminal devices such as computers, smart phones, and personal digital assistants have become indispensible tools for people in the modern society. These terminal devices not only feature Internet connection, but also can be installed with various application programs (e.g., calendar software, navigation software, and office software), allowing people to search for information on the Internet whenever desired, and use the calendar, calculator, web map and/or other functions as needed, which lends great convenience to the users' daily lives.

Take the most common calendar function (also known as electronic calendar function) for example. The calendar software installed in a commercially available terminal device is typically designed to display a daily or monthly calendar into which a user can input schedules for, or things to be done on, specific days so that the calendar serves as a timely reminder. With the advent of the network era, however, the simple reminder function of the conventional calendar software has failed to meet user needs. For instance, one who has marked an electronic calendar with a travel itinerary or sport events may feel the need to gather more information when the marked dates are approaching, and in order to obtain the information (e.g., the weather of the travel destination or the time limits for buying tickets to the sport events), he or she must make extra efforts, such as by surfing the Internet via browser software. That is to say, the conventional electronic calendars, having but a recording and reminding function, can no longer fully satisfy the needs of today's users. Consequently, in the example given above, the user of the electronic calendar must take the trouble of looking for the desired information by him- or herself as the marked dates draw near, and the information gathering process is, without doubt, an onerous and time-consuming one, especially for those with tight work schedules.

Thus, the present inventor has found that, despite the increasing number of Internet-related applications nowadays, the operation mode of the conventional electronic calendars remains, i.e., serving as a schedule recording medium and a reminder of scheduled events, without further interaction with the Internet. As a result, an electronic calendar user wishing to obtain more information about a scheduled event has to search for the information through the Internet or other means. In consideration of this, the inventor of the present invention came up with the idea of improving the process flow of the conventional calendar software so that an electronic calendar can automatically collect news or discussions related to a user-input event or schedule. In this way, not only is the problem associated with the overly simple function of the conventional electronic calendars solved, but also the user-friendliness and convenience of a terminal device equipped with such improved calendar software will be greatly enhanced. The issue to be addressed by the present invention, therefore, is to provide improved calendar software which is to be installed in a terminal device and which, when activated, can provide its user with more information in real time.

### BRIEF SUMMARY OF THE INVENTION

In view of the fact that the calendar software in a conventional terminal device is incapable of providing more information to its user in real time, the inventor of the present invention conducted extensive research and tests based on years of experience and finally succeeded in developing a method for personalizing a calendar by collecting web page information according to data entries in the calendar. The method of the present invention is intended to effectively increase the convenience and ease of use of terminal devices in general.

The present invention provides a method for personalizing a calendar by collecting web page information according to data entries in the calendar. The method is applicable to a network system which includes a terminal device and a server. The terminal device can connect to the server through the Internet and is installed with calendar software. The method includes the following steps to be performed by the network system. To begin with, the terminal device activates the calendar software and performs a login procedure in order to log in to a user account in the server through the calendar software and display a calendar interface. Next, the terminal device receives a data entry which is written into the calendar via an input unit (e.g., a keyboard or a touch screen). The data entry at least includes an event parameter (e.g., the content of an event, the location of the event, and the parties involved in the event) and a date parameter (e.g., the date of the event). The terminal device transmits the data entry to the server, in order for the server to select at least one search criterion (i.e., a keyword in the event parameter) according to the data entry and then, based on the search criterion, collect web page information which not only matches the search criterion, but also corresponds to a predetermined time interval in the vicinity of (e.g., within one year or three months of) the date parameter. Afterward, the server generates a news link (e.g., a uniform resource locator; URL) for each piece of the web page information collected and defines a plurality of information categories (e.g., sports, weather, and life) based on the content of the web page information, such that each news link corresponds to at least one information category. The server then transmits the news links to the terminal device, and the news links are displayed by the terminal device through the calendar software according to the information categories. The method of the present invention is so designed that, after the user writes the predetermined data entry into the calendar via the input unit, the terminal device automatically collects the matching web page information from the Internet by way of the calendar software and the server. Once the web page information collected is properly sorted, the terminal device imbeds the web page information into the calendar or adds the web page information to the calendar as a plugin, thereby creating a personalized calendar which enables the user to obtain the desired information conveniently and rapidly.

### BRIEF DESCRIPTION OF THE SEVERAL VIEWS OF THE DRAWINGS

The techniques employed by, as well as the preferred mode of implementation and the objectives of, the present invention will be best understood by referring to the following detailed description of some illustrative embodiments in conjunction with the accompanying drawings, in which:

FIG. 1 schematically shows a network system according to the present invention;

FIG. 2 schematically shows a calendar interface in the present invention;

FIG. 3 schematically shows an input interface in the present invention;

FIG. 4 schematically shows another calendar interface in the present invention;

FIG. 5 is a flowchart of the steps to be performed by a terminal device in the present invention;

FIG. 6 is a flowchart of the steps to be performed by a server in the present invention; and

FIG. 7 schematically shows yet another calendar interface in the present invention.

### DETAILED DESCRIPTION OF THE INVENTION

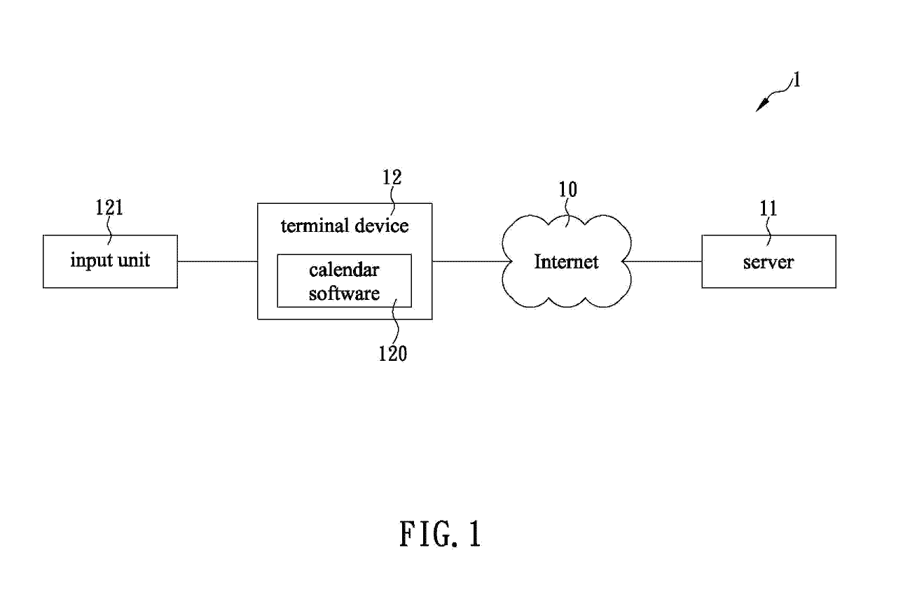

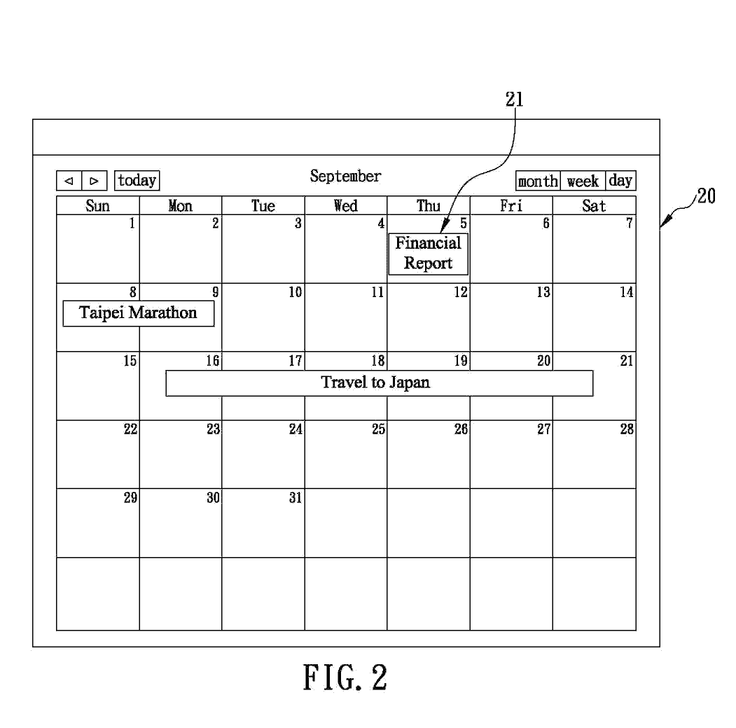

The present invention provides a method for personalizing a calendar by collecting web page information according to data entries in the calendar. Referring to FIG. 1 and FIG. 2, the method is applied to a network system 1, and the network system 1 includes a server 11 and a terminal device 12 (e.g., a smart phone or a laptop computer). The terminal device 12 is configured for connecting to the server 11 through the Internet 10 and is installed with calendar software 120. After the calendar software 120 is activated by the user operating the terminal device 12, the terminal device 12 displays a calendar interface 20.

Referring to FIG. 2 in conjunction with FIG. 1, the calendar interface 20 displays a plurality of data entries, which are input by the user and may include the user's schedules or things to be done by the user. After displaying the calendar interface 20, the terminal device 12 carries out a login procedure through the calendar software 120 (e.g., by generating a login interface through which the user can input a username and a password) in order to log in to a user account in the server 11.

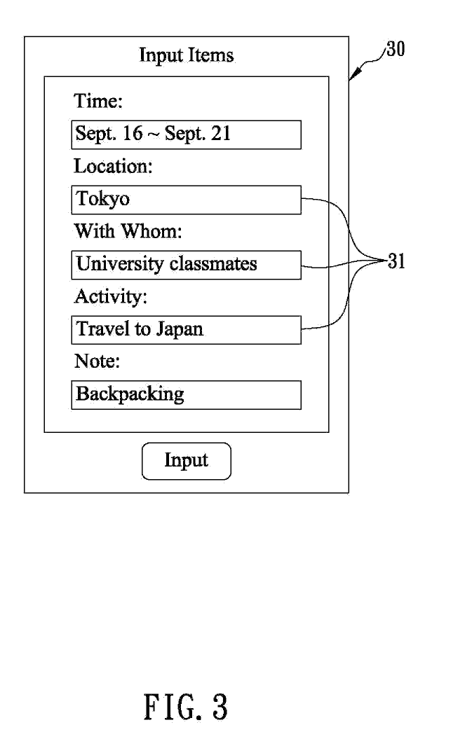

Referring to FIG. 3 in conjunction with FIG. 1, when the user wishes to add a new data entry, the terminal device 12 generates an input interface 30 through the calendar software 120. The input interface 30 is provided with a plurality of input fields 31, allowing the user to write the data entry into the calendar software 120 via an input unit 121 (e.g., a keyboard or touch screen). The data entry is then transmitted to the server 11 through the Internet 10. For example, in the first preferred embodiment of the present invention, as shown in FIG. 3, the data entry includes an event parameter, a date parameter, a parties-involved parameter, and a location parameter. More specifically, in FIG. 3, which corresponds to the data entry of “Travel to Japan”, the event parameter is “Backpacking”, the date parameter is “Sept. 16˜Sept. 21”, the location parameter is “Tokyo”, and the parties-involved parameter is “University classmates”.

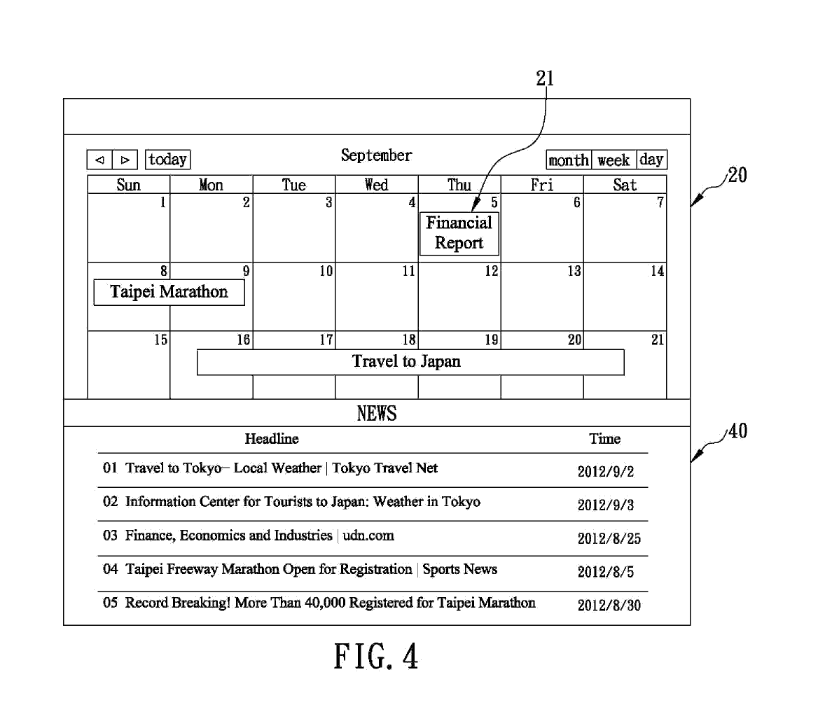

Referring to FIG. 1 to FIG. 3, after the terminal device 12 successively transmits a plurality of data entries 21 to the server 11 through the Internet 10, the server 11 selects at least one search criterion from each data entry 21, wherein the search criterion can be the event parameter, the location parameter, or the parties-involved parameter, and wherein the server 11 may alternatively select a keyword in each parameter as the search criterion. Then, according to the search criteria selected, the server 11 searches the Internet for web page information which not only matches any of the search criteria, but also corresponds to a predetermined time interval (e.g., within the last six months). Once such web page information is found, the server 11 generates a news link (e.g., a URL) for each piece of the web page information. For instance, referring to FIG. 4, in which the data entries include “Travel to Japan”, the web page information collected by the server 11 may include the weather information of Japan or the a web page of the Japan Meteorological Agency.

Besides, referring to FIG. 4 in conjunction with FIG. 1, the server 11 defines a plurality of information categories according to the content of the web page information such that each news link corresponds to at least one information category (e.g., finance, weather, sports, or cuisine). After that, the server 11 transmits the news links to the terminal device 12.

Referring to FIG. 1 to FIG. 4, upon receiving the news links, the terminal device 12 integrates the news links into an information interface 40 according to the information categories. Also, the terminal device 12 displays the information interface 40 at a position corresponding to the calendar interface 20, thereby providing the user with ready and real-time access to news related to the scheduled events. As such, the calendar software 120 features enhanced convenience of use. For example, referring to FIG. 4, the calendar interface 20 includes three data entries, namely “Financial Report”, “Taipei Marathon”, and “Travel to Japan”, and the server 11 has sent back five news links, the first and second of which are related to the travel to Japan and are under the information category of “weather”, the third of which is related to the financial report and under the information category of “finance”, and the fourth and fifth of which are related to the Taipei marathon and under the information category of “sports”.

Referring back to FIG. 1, the method of the present invention is so designed that, after activating the calendar software 120 in the terminal device 12, the user will automatically obtain, through the Internet 10 and the server 11, news links corresponding to the data entries input by the user. Moreover, the news links are shown alongside the calendar interface 20 for easy reference by the user. Therefore, the user no longer has to surf the Internet for information related to each upcoming event in the calendar, and the time otherwise required for searching for such information can be saved. The terminal device 12 thus provides enhanced convenience, up-to-dateness of information, and user-friendliness.

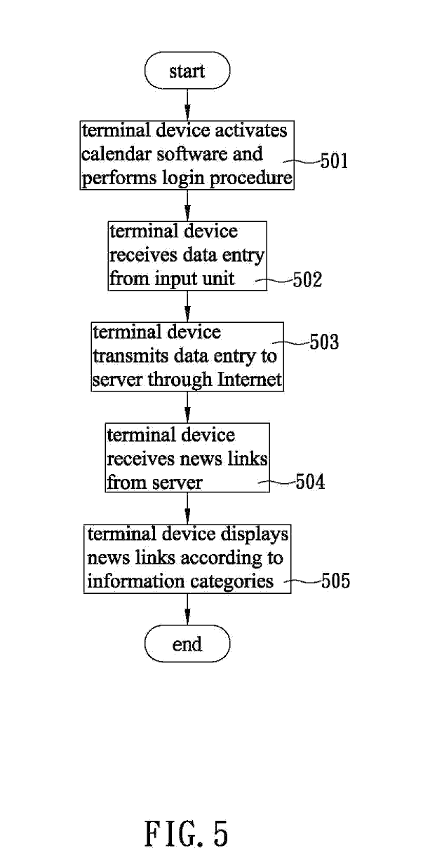

To further illustrate the mode of implementation and the detailed process flow of the present invention, the steps performed by the terminal device 12 in the first preferred embodiment of the present invention are described below with reference to FIG. 5:

(501) Referring to FIG. 1 and FIG. 2, the terminal device 12 activates the calendar software 120, logs in to a user account in the server 11 by performing a login procedure, and displays a calendar interface 20.

(502) The terminal device 12 generates an input interface 30 through the calendar software 120 so that the user can input a data entry 21 into the input fields 31 of the input interface 30 by means of an input unit. The data entry 21 must at least include an event parameter and a date parameter.

(503) After receiving the data entry 21, the terminal device 12 transmits the data entry 21 to the server 11 via the Internet 10.

(504) Once the server 11 has collected related web page information according to the data entry 21, the terminal device 12 receives the news links sent by the server 11.

(505) Based on the categories of the web page information, the terminal device 12 displays the news links at a position corresponding to the calendar interface 20 such that all the news links under the same information category are grouped together for easy reference.

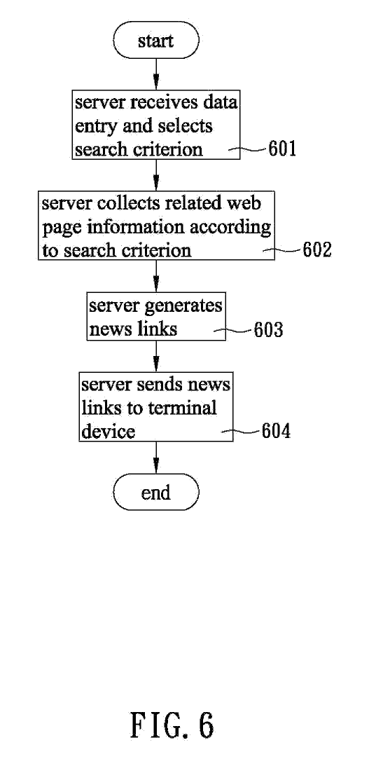

Referring to FIG. 6 in conjunction with FIG. 1 and FIG. 2, the method of the present invention also includes the following steps to be performed by the server 11:

(601) Upon receiving the data entry 21, the server 11 selects at least one search criterion from the data entry 21.

(602) After obtaining the search criterion, the server 11 collects, from the Internet 10, web page information corresponding to a predetermined time interval in the vicinity of the date parameter.

(603) Then, the server 11 generates a news link for each piece of the web page information and defines a plurality of information categories based on the content of the web page information, wherein each news link corresponds to at least one information category.

(604) After generating the news links, the server 11 sends the news links to the terminal device 12.

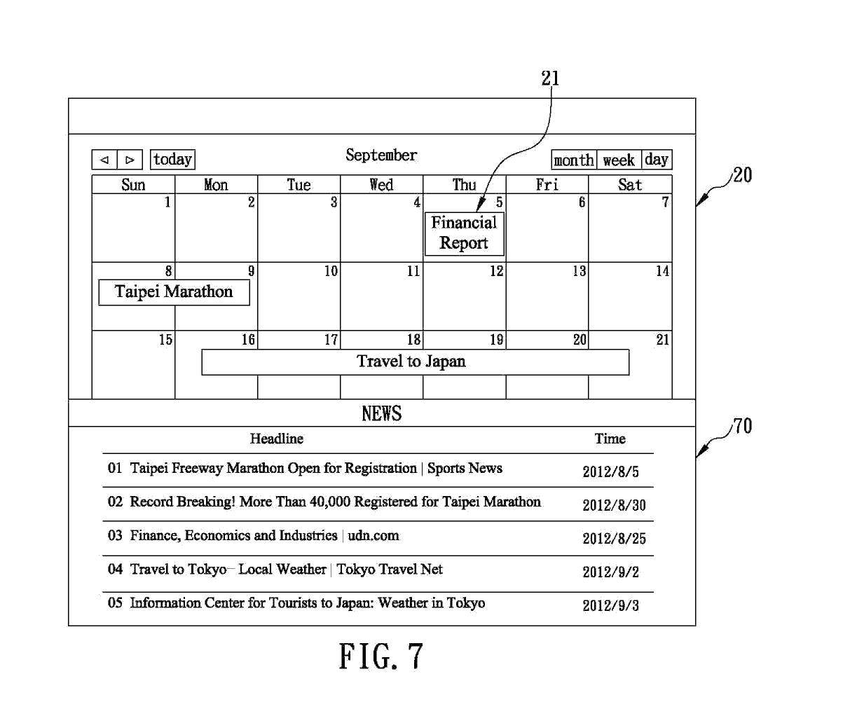

In addition, referring to FIG. 1 to FIG. 4, the terminal device 12 in the first preferred embodiment of the present invention is also configured to record, according to the information categories of the news links, the number of times for which each information category has been read within an operation time (e.g., ten minutes). After the elapse of the operation time, the terminal device 12 rearranges the information interface 40 according to the number of times recorded. In particular, the terminal device 12 will change the sequence of the news links (e.g., with the most frequently read category placed at the top the information interface 40). Referring to FIG. 4 and FIG. 7, assume the user has clicked on the news links 03, 04, and 05 in the information interface 40 in FIG. 4, wherein the aforesaid news links correspond to the information categories “finance” and “sports” respectively, and wherein the category “finance” was clicked once and the category “sports”, twice. So, after a five-minute operation time (whose duration can be freely set by the user), the terminal device 12 puts the finance- and sports-related news links at the top of the information interface 40, followed by the weather-related news links, which arrangement is in line with the levels of the user's attention to the news links displayed. In FIG. 7, the news links under the categories “finance” and “sports” have been rearranged into positions 01˜03 to facilitate clicking.

In other preferred embodiments of the present invention, referring again to FIG. 1 and FIG. 2, each data entry 21 further includes a time period parameter, which indicates a time interval. After receiving the news links, the terminal device 12 proceeds by determining whether the current date falls within the time period parameter. If yes, the terminal device 12 displays the news links through the calendar software 120; if not, meaning the user need not know the information yet, the news links will not be displayed by the terminal device 12. Taking the foregoing “Travel to Japan” for example, the user may set the time period parameter as “within a month” when inputting the data entry “Travel to Japan”. As the date parameter of “Travel to Japan” is “Sept. 16˜Sept. 21”, the terminal device 12 will not display news links related to “Travel to Japan” if the current time is May. If the current time is somewhere between August and September, however, the terminal device 12 will determine, according to the time period parameter, that the user is in need of related news; hence, the terminal device 12 will display the corresponding news links, allowing the user to read the news by clicking on the news links.

In other preferred embodiments of the present invention, referring to FIG. 1, FIG. 2, and FIG. 4, the user may additionally store a set of secondary data entries into the server 11 through the Internet 10, wherein the secondary data entries correspond to the user account and may include things to be done (e.g., an appointment with the dentist) or an electronic newsletter complying with the RSS (Really Simple Syndication) specifications. After the server 11 has completed the collection of information and generated the corresponding news links, the news links are transmitted from the server 11 to the terminal device 12 along with the secondary data entries, in order for the terminal device 12 to incorporate the secondary data entries into the information interface 40 for display. Thus, in addition to being reminded of the data entries 21 previously input into the calendar interface 20, the user can check out the electronic newsletters subscribed. This technical feature adds completeness, as well as flexibility in use, to the functions of the terminal device 12.

It should be pointed out that, although the terminal device 12 in the embodiment shown in FIG. 1 and FIG. 4 is configured for integrating the news links into the information interface 40 and displaying the information interface 40 at a position adjacent to the calendar interface 20, the terminal device 12 in another preferred embodiment of the present invention may also be configured for directly imbedding the news links into the calendar interface 20 (e.g., by imbedding the news links into the date field(s) of the corresponding data entries 21 respectively) or imbedding the information interface 40 into the calendar interface 20 such that the two interfaces are united as one.

While the invention herein disclosed has been described by means of specific embodiments, numerous modifications and variations could be made thereto by those skilled in the art without departing from the scope of the invention set forth in the claims.

What is claimed is:

1. A method for personalizing a calendar by collecting web page information according to data entries in the calendar, the method being applicable to a network system comprising a terminal device and a server, the terminal device being connectable to the server through the Internet and being installed with calendar software, the method comprising the steps, to be performed by the network system, of:
activating the calendar software and performing a login procedure, by the terminal device, in order for the terminal device to log in to a user account in the server through the calendar software and display a calendar interface;
receiving, by the terminal device, a data entry written into the calendar software via an input unit, wherein the data entry at least includes an event parameter and a date parameter;
transmitting the data entry to the server, by the terminal device;
selecting at least a search criterion according to the data entry and collecting, from the Internet according to the search criterion, web page information matching the search criterion and corresponding to a predetermined time interval in a vicinity of the date parameter, by the server,
generating a news link for each piece of the web page information and defining a plurality of information categories according to content of the web page information, by the server, such that each said news link corresponds to at least a said information category;
transmitting the news links to the terminal device, by the server; and
displaying the news links by the terminal device through the calendar software according to the information categories.

2. The method of claim 1, further comprising the step, to be performed by the terminal device within an operation time, of recording, according to the information categories of the news links, the number of times for which each said information category has been read, in order for the terminal device to rearrange the news links according to the recorded number of times after the operation time ends.

3. The method of claim 2, wherein the data entry further includes a time period parameter, and the terminal device will not display the news links through the calendar software unless the terminal device determines, upon receiving the news links, that a current date matches the time period parameter.

4. The method of claim 3, wherein the terminal device imbeds the news links into the calendar interface.

5. The method of claim 1, wherein the server stores a set of secondary data entries corresponding to the user account and transmits both the news links and the secondary data entries to the terminal device after generating the news links, and the terminal device displays the news links and the secondary data entries simultaneously.

6. The method of claim 2, wherein the server stores a set of secondary data entries corresponding to the user account and transmits both the news links and the secondary data entries to the terminal device after generating the news links, and the terminal device displays the news links and the secondary data entries simultaneously.

7. The method of claim 3, wherein the server stores a set of secondary data entries corresponding to the user account and transmits both the news links and the secondary data entries to the terminal device after generating the news links, and the terminal device displays the news links and the secondary data entries simultaneously.

8. The method of claim 4, wherein the server stores a set of secondary data entries corresponding to the user account and transmits both the news links and the secondary data entries to the terminal device after generating the news links, and the terminal device displays the news links and the secondary data entries simultaneously.

9. The method of claim 5, wherein the secondary data entries conform to Really Simple Syndication specifications.

10. The method of claim 6, wherein the secondary data entries conform to Really Simple Syndication specifications.

11. The method of claim 7, wherein the secondary data entries conform to Really Simple Syndication specifications.

12. The method of claim 8, wherein the secondary data entries conform to Really Simple Syndication specifications.

13. The method of claim 5, further comprising the step, to be performed by the terminal device after activating the calendar software, of generating an input interface through the calendar software in order to receive the data entry from the input unit.

14. The method of claim 6, further comprising the step, to be performed by the terminal device after activating the calendar software, of generating an input interface through the calendar software in order to receive the data entry from the input unit.

15. The method of claim 7, further comprising the step, to be performed by the terminal device after activating the calendar software, of generating an input interface through the calendar software in order to receive the data entry from the input unit.

16. The method of claim 8, further comprising the step, to be performed by the terminal device after activating the calendar software, of generating an input interface through the calendar software in order to receive the data entry from the input unit.
